(19) United States
(12) Patent Application Publication
(10) Pub. No.: US 2012/0177882 A1
(43) Pub. Date: Jul. 12, 2012

(54) Decorative Stone Compositions and Methods

(76) Inventor: Laszlo Sichtnik, Bronx, NY (US)

(21) Appl. No.: 13/004,157

(22) Filed: Jan. 11, 2011

(51) Int. Cl. C04B 28/26; B29C 70/00; B32B 9/00

(52) U.S. Cl. 428/142; 264/69

(57) ABSTRACT

A decorative stone composition is disclosed. The decorative stone composition is prepared by the process including mixing an agglomerated stone composition, curing the agglomerated stone composition; treating the surface of the cured agglomerated stone composition with one or more texturing compositions; and curing the one or more texturing compositions.

### BACKGROUND OF THE INVENTION

Natural cut and carved stone has been used in, for example, buildings, monuments, and statues. However, the use of natural cut and carved stone is usually prohibitively expensive for most people. As a result, various manufactured or engineered stone compositions have been developed to simulate cut and carved stone.

For example, terrazzo is a cement-based artificial stone containing white cement and assorted aggregates. To form a smooth surface, the exposed aggregates must be ground down. Further, terrazzo does not provide a realistic stone texture since the aggregates are surrounded by a white cement paste.

As such, there is a need for a casting compound that can simulate different kind of stones like limestone, granite, sandstone, marble and noble stones. There is also a need for a casting compound, which after setting and demolding, does not require sanding, grinding and polishing to expose its aggregates. There is also a need for a casting compound that can produce a polished stone look without labor intensive surface finishing techniques.

The invention, as disclosed herein, fulfills those needs.

### SUMMARY OF THE INVENTION

The present invention provides realistic, finished, decorative stone compositions with very little surface manipulation. The present invention provides the decorative industries and art field with a new inventive polymeric agglomerated cast stone. The present invention has the versatility to produce a wide variety of different kind of stones, for example, limestone, sandstone, granite, marble and the like. The present invention provides a casting mixture, which after curing and demolding from a smooth inner surface mold, produces a polished highly textured surface without the laborious work of grinding sanding, and polishing. The decorative stone composition has a striking resemblance of its natural counterpart. The decorative stone composition is water stable, weather stable, and ultraviolet light stable. The decorative stone composition has a compressive strength of at least about 5000-6000 pounds per square inch and has good impact resistance. Further, the decorative stone composition reproduces the original piece with high fidelity. As such, the decorative stone composition makes an ideal medium for reproduction of three-dimensional architectural decorative and artistic pieces.

The present invention provides a decorative stone composition prepared by the process including: mixing an agglomerated stone composition including kaolin, coal ash, blast furnace slag, or the combination thereof; one or more alkali metal silicates; one or more alkali metal hydroxides; one or more aggregate materials; water; curing the agglomerated stone composition; treating the surface of the cured agglomerated stone composition with one or more texturing compositions; and curing the one or more texturing compositions.

In one embodiment, the decorative stone composition is used as an architectural ornament statute, a mosaic, a decorative tile, a casting compound, a composition for matching color and texture in the restoration of an old building, a corbel, a column, a balustrade, an ornamental precast, a fireplace surround, a window surround, a door surround, a mural, a sculpture, rosettes, moldings, capital, medallions, floor coverings, paver tiles, a inlay into wood, a stone, an ortiel by cutting out a form in a sheet of material and replacing it with the decorative stone composition, or a combination thereof.

In one embodiment, the kaolin includes metakaolin. In one embodiment, the metakaolin is a highly reactive metakaolin. In one embodiment, the metakaolin is a synthetic metakaolin. In one embodiment, the highly reactive metakaolin includes greater than about 50 percent reactive amorphous aluminum silicate.

In one embodiment, the coal ash includes fly ash. In one embodiment, the coal ash includes bottom ash. In one embodiment, the one or more alkali metal silicates each independently include lithium silicate, sodium silicate, potassium silicate, rubidium hydroxide, caesium hydroxide, or a combination thereof.

In one embodiment, the one or more alkali metal silicates include sodium silicate and potassium silicate. In one embodiment, the one or more alkali metal silicates include lithium silicate. In one embodiment, the one or more alkali metal silicates include sodium silicate. In one embodiment, the one or more alkali metal silicates include potassium silicate.

In one embodiment, the one or more alkali metal silicates includes an aqueous solution from about 10 weight percent to about 55 weight percent solid. In one embodiment, the one or more alkali metal silicates includes an aqueous solution from about 25 weight percent to about 40 weight percent solid. In one embodiment, the one or more alkali metal silicates includes a weight ratio of silicon dioxide to alkali metal silicate from about 30 weight percent to about 55 weight percent solid.

In one embodiment, the one or more alkali metal silicates includes a weight ratio of silicon dioxide to alkali metal silicate from about 35 weight percent to about 52 weight percent solid. In one embodiment, the potassium silicate in a weight ratio of silicon dioxide to potassium silicate from about 36 weight percent to about 49 weight percent solid. In one embodiment, the potassium silicate includes an aqueous solution from about 20 weight percent to about 50 weight percent solid.

In one embodiment, the one or more alkali metal hydroxides each independently include lithium hydroxide, sodium hydroxide, potassium hydroxide, rubidium hydroxide, caesium hydroxide, or a combination thereof. In one embodiment, the one or more alkali metal hydroxides each independently include lithium hydroxide, sodium hydroxide, potassium hydroxide, or a combination thereof. In one embodiment, the one or more alkali metal hydroxides include lithium hydroxide.

In one embodiment, the one or more alkali metal hydroxides include sodium hydroxide. In one embodiment, the one or more alkali metal hydroxides include potassium hydroxide.

In one embodiment, the one or more aggregate materials each independently include one or more granites, one or more marbles, one or more limestones, one or more sandstones, one or more semi-precious stones, one or more precious stones, one or more sands, one or more sea shells, one or more glasses, one or more bricks, one or more clinkers, one or more ceramics, one or more plastics, one or more semi-precious metals, one or more precious metals, one or more furnace slags, one or more granulated blast furnace slags, one or more volcanic stones, a combination thereof. In one embodiment, the one or more aggregate materials are one or more crushed aggregates.

In one embodiment, the one or more crushed aggregates has a particle size distribution of about 20 to 40 weight percent of size #000 mesh, about 30 to 50 weight percent of size #00 mesh, about 30 to 50 weight percent of size #0 mesh, about 20 to 30 weight percent of size #1 mesh.

In one embodiment, the one or more crushed aggregates has a particle size distribution of about 10 to 30 weight percent of size #000 mesh, about 50 to 70 weight percent of size #00 mesh, and about 10 to 40 weight percent of size #0 mesh. In one embodiment, the one or more crushed aggregate materials each independently include one or more naturally low reflective aggregates, one or more naturally highly reflective aggregates, or a combination thereof.

In one embodiment, the one or more precious stones each independently include diamond, ruby, sapphire, emerald, or a combination thereof. In one embodiment, the one or more semi-precious stones each independently include garnet, amethyst, aquamarine, peridot, opal, pearl, topaz, amber, jet, coral, ivory, quartz, hematite, pyrite, jasper, onyx, jade, tourmaline, or a combination thereof.

In one embodiment, the one or more precious metals each independently include gold, silver, copper, platinum, palladium ruthenium, rhodium, osmium, iridium, germanium, gallium, or a combination thereof. In one embodiment, the one or more semi-precious metals each independently include nickel, bismuth, tellurium, zinc, iron, or a combination thereof. In one embodiment, the one or more plastics each independently include a thermoset, an elastomer, a thermoplastic, or a combination thereof.

In one embodiment, the one or more texturing compositions each independently include one or more silicon resins, one or more waxes, one or more acrylic resins, one or more polyester resins, one or more epoxy resins, one or more epoxy-silicon resins, one or more polyurethane resins, or a combination thereof. In one embodiment, the one or more texturing compositions each independently include one or more silicon resins.

In one embodiment, the one or more silicon resins each independently include one or more hyper branched poly(alkylalkoxysiloxane) resins, one or more hyper branched poly(vinylalkoxysiloxane) resins, one or more dendrical poly(alkylalkoxysiloxane) resins, one or more dendrical poly(vinylalkoxysiloxane) resins, or a combination thereof.

In one embodiment, the one or more hyper branched poly(alkylalkoxyoxysiloxane) resins each independently include hyper branched poly(alkylmethoxysiloxane), hyper branched poly(alkylethoxysiloxane), or a combination thereof. In one embodiment, the one or more silicon resins each independently include about 20 to 40 mole percent branched polysiloxane, about 40 to 60 mole percent linear or cyclic polysiloxane, about 10 to 30 mole percent terminal polysiloxane, and about 1 to 5 mole percent monomeric siloxane.

In one embodiment, the one or more silicon resins each independently include about 29 mole percent Q₃-branched polysiloxane (SiSi(R)O₃—), about 50 mole percent Q₂ linear chain or cyclic polysiloxane (Si(R₂)O₂—), about 19 mole percent Q₁ terminal polysiloxane (Si(R₃)O—), and about 2 mole percent Q₀ monomeric siloxane (Si(R)₄).

In one embodiment, the one or more silicon resins each independently include about 25 to 35 mole percent branched polysiloxane, about 45 to 55 mole percent linear or cyclic polysiloxane, about 15 to 25 mole percent terminal polysiloxane, and about 1 to 3 mole percent monomeric siloxane with or without aliphatic solvent or aromatic solvent.

In one embodiment, the one or more silicon resins each independently include about 29 mole percent branched polysiloxane, about 50 mole percent linear or cyclic polysiloxane, about 19 mole percent terminal polysiloxane, and about 2 mole percent monomeric siloxane.

In one embodiment, the one or more waxes each independently include one or more mineral waxes, one or more animal waxes, one or more plant waxes, one or more natural crystalline waxes, one or more synthetic crystalline waxes, or a combination thereof. In one embodiment, the one or more mineral waxes each independently include paraffin, montan wax, lignite wax, osocerite, ceresin, utah wax, or peat wax. In one embodiment, the one or more animal waxes each independently include beeswax, Chinese wax, shellac wax, spermaceti, or wool wax. In one embodiment, the one or more plant waxes each independently include bayberry, candelilla, carnauba, cotton, esparto, fir, Japan, ouricury, palm, rice-oil, sugar cane, ucuhuba, or cocoa butter.

In one embodiment, the one or more polyester resins each independently include one or more hydroxyl polyester resins, one or more carboxyl polyester resins, one or more isophthalic polyester resins, one or more orthophthalic polyester resins, or a combination thereof.

In one embodiment, the one or more epoxy resins each independently include one or more glycidyl epoxy resins, one or more non-glycidyl resins, or a combination thereof. In one embodiment, the one or more glycidyl epoxy resins each independently include one or more glycidyl-ether epoxy resins, one or more glycidyl-ester epoxy resins, one or more glycidyl-amine epoxy resins, or a combination thereof. In one embodiment, the one or more non-glycidyl epoxy resins each independently include one or more aliphatic epoxy resins, one or more cycloaliphatic resins, or a combination thereof. In one embodiment, the one or more epoxy resins each independently include one or more low viscosity, slow setting, and clear epoxy resins.

In one embodiment, the one or more texturing compositions each independently include one or more solvent based texturing compositions, one or more solvent-free texturing compositions, or a combination thereof. In one embodiment, the solvent based texturing compositions include an aliphatic solvent, an aromatic solvent, or a combination thereof.

In one embodiment, mixing an agglomerated stone composition includes mixing by hand or by machine to provide a mixed agglomerated stone composition. In one embodiment, the decorative stone composition further includes blending a second agglomerated stone composition into the mixed agglomerate stone composition to provide a blended agglomerated stone composition.

In one embodiment, the mixed agglomerate stone composition and the second agglomerated stone composition are each independently distinctly visible in the blended agglomerated stone composition.

In one embodiment, the decorative stone composition further includes casting a mixed agglomerated stone composition into a mold with a smooth inner surface. In one embodiment, the mold has an inner surface including plastic, rubber, metal, wood, cloth, paper, or a combination thereof. In one embodiment, a molded mixed agglomerated stone composition is vibrated prior to curing.

In one embodiment, the curing a mixed agglomerated stone composition includes heating the mixed agglomerated stone composition to about 80 degrees Fahrenheit to about 200 degrees Fahrenheit for about two hours to about 24 hours at ambient pressure. In one embodiment, the curing a mixed agglomerated stone composition includes heating the mixed agglomerated stone composition to about 210 degrees Fahrenheit to about 400 degrees Fahrenheit for about two hours to about 24 hours at a pressure at about 1 bar to about 17 bar.

In one embodiment, the curing of the mixed agglomerated stone composition is performed in a sealed container. In one embodiment, the treating the surface of the cured agglomerated stone composition with one or more texturing compositions includes brushing the surface of the cured agglomerated stone composition with the one or more texturing compositions with vibration. In one embodiment, the treating the surface of the cured agglomerated stone composition with one or more texturing compositions includes brushing the surface of the cured agglomerated stone composition with the one or more texturing compositions without vibration.

In one embodiment, the treating the surface of the cured agglomerated stone composition with one or more texturing compositions includes dipping the surface of the cured agglomerated stone composition into the one or more texturing compositions. In one embodiment, the curing the one or more texturing compositions includes leaving the cured agglomerated stone composition with one or more texturing compositions at about room temperature for about 24 hours. In one embodiment, the agglomerated stone composition includes a potassium oxide to silicon dioxide mole ratio from about 0.1 to about 0.4.

In one embodiment, the agglomerated stone composition includes a potassium oxide to silicon dioxide mole ratio from about 0.2 to about 0.3. In one embodiment, the agglomerated stone composition includes a silicon dioxide to aluminum oxide mole ratio from about 1.0 to about 5.0. In one embodiment, the agglomerated stone composition includes a silicon dioxide to aluminum oxide mole ratio from about 2.0 to about 4.0. In one embodiment, the agglomerated stone composition includes water to potassium oxide mole ratio from about 16 to about 22.

In one embodiment, the agglomerated stone composition includes water to potassium oxide mole ratio from about 18 to about 20. In one embodiment, the agglomerated stone composition includes a potassium oxide to aluminum oxide mole ratio from about 0.2 to about 1.5. In one embodiment, the agglomerated stone composition includes a potassium oxide to aluminum oxide mole ratio from about 0.4 to about 1.1.

In one embodiment, the agglomerated stone composition includes water to aluminum oxide mole ratio from about 5 to about 25. In one embodiment, the agglomerated stone composition includes water to aluminum oxide mole ratio from about 10 to about 20.

In one embodiment, the agglomerated stone composition further includes a colorant. In one embodiment, the colorant includes a dye, a pigment, or a combination thereof.

The present invention provides a decorative stone composition including: a cured agglomerated stone composition having an exterior surface including: kaolin, coal ash, blast furnace slag, or the combination thereof; one or more alkali metal silicates; one or more alkali metal hydroxides; one or more aggregate materials; water; and one or more cured texturing layers on the exterior surface of the cured agglomerated stone composition.

The present invention provides a method of making a decorative stone composition. The method includes: preparing agglomerated stone composition including: kaolin, coal ash, blast furnace slag, or the combination thereof; one or more alkali metal silicates; one or more alkali metal hydroxide; one or more aggregate materials; water; preparing a mold having an inner surface; optionally applying a form releasing agent, a defoaming agent, or a combination thereof to the inner surface of the mold; casting the agglomerated stone composition in the mold; optionally consolidating the mixed agglomerated stone composition in the mold; optionally placing one or more rebars or one or more meshes into the mixed agglomerated stone composition; curing the agglomerated stone composition in the mold; releasing the cured agglomerated stone composition from the mold; applying one or more texturing compositions to the exterior surface of the cured agglomerated stone composition; optionally applying vibration or vacuum to the one or more texturing compositions on the exterior surface of the cured agglomerated stone composition; and curing the one or more texturing compositions.

In one embodiment, the optionally consolidating the mixed agglomerated stone composition in the mold includes aging at room temperature for about 2 to about 24 hours

The present invention provides an agglomerated stone composition prepared by the process including: mixing an agglomerated stone composition including kaolin, coal ash, blast furnace slag, or the combination thereof; one or more alkali metal silicates; one or more alkali metal hydroxides; one or more aggregate materials; water; and curing the agglomerated stone composition.

The present invention provides an agglomerated stone composition including: kaolin, coal ash, blast furnace slag, or the combination thereof; one or more alkali metal silicates; one or more alkali metal hydroxides; and water.

The present invention provides a method of making a decorative stone composition. The method includes: mixing an agglomerated stone composition including kaolin, coal ash, blast furnace slag, or the combination thereof; one or more alkali metal silicates; one or more alkali metal hydroxides; one or more aggregate materials; water; and curing the agglomerated stone composition.

### BRIEF DESCRIPTION OF THE DRAWINGS

Embodiments of the invention may be best understood by referring to the following description and accompanying drawings, which illustrate such embodiments. In the drawings:

FIG. 1 is a block diagram illustrating an exemplary method of producing a decorative stone composition.

The drawings are not necessarily to scale. Like numbers used in the figures refer to like components, steps, and the like. However, it will be understood that the use of a number to refer to a component in a given figure is not intended to limit the component in another figure labeled with the same number.

### DETAILED DESCRIPTION OF THE INVENTION

The present invention provides realistic, finished, decorative stone compositions with very little surface manipulation. The present invention provides the decorative industries and art field with a new inventive polymeric agglomerated cast stone. The present invention has the versatility to produce a wide variety of different kind of stones, for example, limestone, sandstone, granite, marble and the like. The present invention provides a casting mixture, which after curing and demolding from a smooth inner surface mold, produces a polished highly textured surface without the laborious work of grinding sanding, and polishing. The decorative stone composition has a striking resemblance of its natural counterpart. The decorative stone composition is water stable, weather stable, and ultraviolet light stable. The decorative stone composition has a compressive strength of at least about 5000-6000 pounds per square inch and has good impact resistance. Further, the decorative stone composition reproduces the original piece with high fidelity. As such, the decorative stone composition makes an ideal medium for reproduction of three-dimensional architectural decorative and artistic pieces.

The following detailed description includes references to the accompanying drawings, which form a part of the detailed description. The drawings show, by way of illustration, specific embodiments in which the invention may be practiced. These embodiments, which are also referred to herein as “examples,” are described in enough detail to enable those skilled in the art to practice the invention. The embodiments may be combined, other embodiments may be utilized, or structural, and logical changes may be made without departing from the scope of the present invention. The following detailed description is, therefore, not to be taken in a limiting sense, and the scope of the present invention is defined by the appended claims and their equivalents.

Before the present invention is described in such detail, however, it is to be understood that this invention is not limited to particular variations set forth and may, of course, vary. Various changes may be made to the invention described and equivalents may be substituted without departing from the true spirit and scope of the invention. In addition, many modifications may be made to adapt a particular situation, material, composition of matter, process, process act(s) or step(s), to the objective(s), spirit or scope of the present invention. All such modifications are intended to be within the scope of the claims made herein.

Methods recited herein may be carried out in any order of the recited events which is logically possible, as well as the recited order of events. Furthermore, where a range of values is provided, it is understood that every intervening value, between the upper and lower limit of that range and any other stated or intervening value in that stated range is encompassed within the invention. Also, it is contemplated that any optional feature of the inventive variations described may be set forth and claimed independently, or in combination with any one or more of the features described herein.

The referenced items are provided solely for their disclosure prior to the filing date of the present application. Nothing herein is to be construed as an admission that the present invention is not entitled to antedate such material by virtue of prior invention.

Unless otherwise indicated, the words and phrases presented in this document have their ordinary meanings to one of skill in the art. Such ordinary meanings can be obtained by reference to their use in the art and by reference to general and scientific dictionaries, for example, Webster's Third New International Dictionary, Merriam-Webster Inc., Springfield, Mass., 1993 and The American Heritage Dictionary of the English Language, Houghton Mifflin, Boston Mass., 1981.

The following explanations of certain terms are meant to be illustrative rather than exhaustive. These terms have their ordinary meanings given by usage in the art and in addition include the following explanations.

As used herein, the term “about” refers to a variation of 10 percent of the value specified; for example about 50 percent carries a variation from 45 to 55 percent.

As used herein, the term “and/or” refers to any one of the items, any combination of the items, or all of the items with which this term is associated.

As used herein, the singular forms “a,” “an,” and “the” include plural reference unless the context clearly dictates otherwise. It is further noted that the claims may be drafted to exclude any optional element. As such, this statement is intended to serve as antecedent basis for use of such exclusive terminology as “solely,” “only,” and the like in connection with the recitation of claim elements, or use of a “negative” limitation.

As used herein, the term “alkali metal” refers to a metal in Group I of the periodic table, and includes lithium (Li), sodium (Na), potassium (K), rubidium (Rb), and cesium (Cs).

As used herein, the term “alkali metal hydroxide” refers to a salt that includes an alkali metal cation and a hydroxide (OH⁻) anion. Examples of alkali metal hydroxides include LiOH, NaOH, KOH, RbOH, and CsOH.

As used herein, the term “alkali metal silicate” refers to a salt that includes an alkali metal cation, silicon (Si), oxygen (O), and can optionally contain hydrogen (H).

As used herein, the term “bottom ash” refers to ash that collects at the bottom of the combustion chamber, which is also called “clinker ash.” Typically, bottom ash occupies about 10-15% of the total amount of coal ash generated.

As used herein, the term “clay” refers to a crystalline form of hydrated aluminum silicate. The crystals of clay are irregularly shaped and insoluble in water.

As used herein, the term “coal ash” refers to the residue produced in power plant boilers or coal burning furnaces, for example, chain grate boilers, pulverized coal boilers and fluidized bed boilers, from burning pulverized anthracite or lignite, or bituminous or sub-bituminous coal.

As used herein, the term “coupled” means the joining of two members directly or indirectly to one another. Such joining may be stationary in nature or movable in nature and/or such joining may allow for the flow of fluids, electricity, electrical signals, or other types of signals or communication between two members. Such joining may be achieved with the two members or the two members and any additional intermediate members being integrally formed as a single unitary body with one another or with the two members or the two members and any additional intermediate members being attached to one another. Such joining may be permanent in nature or alternatively may be removable or releasable in nature.

As used herein, the term “fly ash” refers to fine solid particles of coal ash (5-50 millimicron) that are carried away by draft or by waste gases.

As used herein, the terms “include,” “for example,” “such as,” and the like are used illustratively and are not intended to limit the present invention.

As used herein, the term “kaolin” refers to a soft, earthy aluminosilicate clay (and, more specifically, to a dioctahedral phyllosilicate clay) having the chemical formula Al₂Si₂O₅(OH)₄. Kaolin is a naturally occurring layered silicate mineral having alternating tetrahedral sheets and octahedral sheets of alumina octahedra linked via the oxygen atoms of hydroxyl groups. Kaolin includes about 50% alumina, about 50% silica, and trace impurities.

As used herein, the terms “preferred” and “preferably” refer to embodiments of the invention that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the invention.

As used herein, the terms “front,” “back,” “rear,” “upper,” “lower,” “right,” and “left” in this description are merely used to identify the various elements as they are oriented in the FIGS, with “front,” “back,” and “rear” being relative apparatus. These terms are not meant to limit the element which they describe, as the various elements may be oriented differently in various applications.

As used herein, whenever a numerical range, such as 1-10 or 5% to 50%, appears herein, the range encompasses the entire range bounded by the first and last recited value. For example, “a formulation including 1% to 10% by weight oil,” which means that the formulation includes by weight 1%, 1.1%, 1.2%, 1.3%, 1.4%, 1.5%, 1.6%, 1.7%, 1.8%, 1.9%, 2%, 2.1%, 9.7%, 9.8%, 9.9% or 10% oil.

As used herein, the term “mesh” refers to the number of particles per unit scale; thus, the greater the mesh, the finer the granule, Further, mesh sizes are generally understood to indicate an average mesh size of a given collection of particles since each particle within a particular “mesh size” may actually vary over a small distribution of sizes.

As used herein, the term “#000 mesh” refers to a mesh with openings from between about 1/64 inch to about 1/32 inch.

As used herein, the term “#00 mesh” refers to a mesh with openings from between about 1/32 inch to about 1/16 inch.

As used herein, the term “#0 mesh” refers to a mesh with openings from between about 1/16 inch to about ⅛ inch.

As used herein, the term “#1 mesh” refers to a mesh with openings from between about ⅛ inch to about ¼ inch.

The present invention provides a decorative stone composition prepared by the process including: mixing an agglomerated stone composition including kaolin, coal ash, blast furnace slag, or the combination thereof; one or more alkali metal silicates; one or more alkali metal hydroxides; one or more aggregate materials; water; curing the agglomerated stone composition; treating the surface of the cured agglomerated stone composition with one or more texturing compositions; and curing the one or more texturing compositions.

Suitable kaolins may include, for example, kaolinite, dickite, nacrite, antigorite, anauxite, halloysite, indellite, chrysotile, or a combination thereof. In one embodiment, the kaolin includes metakaolin. In one embodiment, the metakaolin is a synthetic metakaolin. In one embodiment, the highly reactive metakaolin includes greater than about 50 percent reactive amorphous aluminum silicate.

Suitable highly reactive metakaolin may be, for example, water-processed to lighten its color, remove inert impurities, and control particle-size distribution. The controlled refining process results in an almost 100% reactive white powder. This process provides a very fine, highly reactive, off white metakaolin, which provides high strength, fine structure, and good aesthetic features. Typical characteristics of the highly reactive metakaolin may have, for example, a particle size distribution including about 34 percent of particles are in the submicron range, about 89 percent of particles are in the submicron range of 5 micron or less, and about 99 percent of particles are in the submicron range of 10 micron or less. Typical medium particle size may be about 1.2 micron.

Suitable coal ash may include, for example, fly ash, bottom ash, or a combination thereof.

Suitable alkali metal silicates may include, for example, lithium silicate, sodium silicate, potassium silicate, rubidium hydroxide, caesium hydroxide, or a combination thereof. Preferably, the one or more alkali metal silicates each independently include sodium silicate and potassium silicate.

Typically, the one or more alkali metal silicates are in an aqueous solution from about 10 weight percent to about 55 weight percent solid. In one embodiment, the one or more alkali metal silicates includes an aqueous solution from about 25 weight percent to about 40 weight percent solid, preferably, from about 30 weight percent to about 55 weight percent solid.

Typically, the one or more alkali metal silicates includes a weight ratio of silicon dioxide to alkali metal silicate from about 35 weight percent to about 52 weight percent solid.

Typically, the potassium silicate in a weight ratio of silicon dioxide to potassium silicate from about 36 weight percent to about 49 weight percent solid, preferably, the potassium silicate includes an aqueous solution from about 20 weight percent to about 50 weight percent solid.

Suitable alkali metal hydroxides may include, for example, lithium hydroxide, sodium hydroxide, potassium hydroxide, rubidium hydroxide, caesium hydroxide, or a combination thereof, preferably, lithium hydroxide, sodium hydroxide, potassium hydroxide, or a combination thereof.

Suitable aggregate materials may include, for example, one or more granites, one or more marbles, one or more limestones, one or more sandstones, one or more semi-precious stones, one or more precious stones, one or more sands, one or more sea shells, one or more glasses, one or more bricks, one or more clinkers, one or more ceramics, one or more plastics, one or more semi-precious metals, one or more precious metals, one or more furnace slags, one or more granulated blast furnace slags, one or more volcanic stones, a combination thereof.

Preferably, the one or more aggregate materials are one or more crushed aggregates. Typically, the one or more crushed aggregates has a particle size distribution of about 20 to 40 weight percent of size #000 mesh, about 30 to 50 weight percent of size #00 mesh, about 30 to 50 weight percent of size #0 mesh, about 20 to 30 weight percent of size #1 mesh, or a particle size distribution of about 10 to 30 weight percent of size #000 mesh, about 50 to 70 weight percent of size #00 mesh, and about 10 to 40 weight percent of size #0 mesh.

Suitable crushed aggregate materials may include, for example, naturally low reflective aggregates, one or more naturally highly reflective aggregates, or a combination thereof.

Suitable precious stones may include, for example, diamond, ruby, sapphire, emerald, or a combination thereof. Suitable semi-precious stones e may include, for example, garnet, amethyst, aquamarine, peridot, opal, pearl, topaz, amber, jet, coral, ivory, quartz, hematite, pyrite, jasper, onyx, jade, tourmaline, or a combination thereof.

Suitable precious metals may include, for example, gold, silver, copper, platinum, palladium ruthenium, rhodium, osmium, iridium, germanium, gallium, or a combination thereof. Suitable semi-precious metals may include, for example, nickel, bismuth, tellurium, zinc, iron, or a combination thereof.

Suitable plastics may include, for example, a thermoset, an elastomer, a thermoplastic, or a combination thereof. Suitable plastics may include, for example, polymethylmethacrylate plastic, strength-modified polymethylmethacrylate, polycarbonate plastic, polystyrene plastic, styrene-acrylic-nitrile plastic, polyethylene terephthalate plastic, glycol-modified polyethylene terephthalate plastic, polyvinyl chloride plastic, transparent polyolefin plastic, acrylonitrile-butadiene-styrene (ABS) plastic, mixtures (blends) of various thermoplastics, or combinations thereof.

Suitable texturing compositions may include, for example, one or more silicon resins, one or more waxes, one or more acrylic resins, one or more polyester resins, one or more epoxy resins, one or more epoxy-silicon resins, one or more polyurethane resins, or a combination thereof. Suitable texturing compositions may include, for example, one or more silicon resins. Suitable silicon resins may include, for example, one or more hyper branched poly(alkylalkoxysiloxane) resins, one or more hyper branched poly(vinylalkoxysiloxane) resins, one or more dendrical poly(alkylalkoxysiloxane) resins, one or more dendrical poly(vinylalkoxysiloxane) resins, or a combination thereof.

Typically, the one or more hyper branched poly(alkylalkoxyoxysiloxane) resins may include, for example, hyper branched poly(alkylmethoxysiloxane), hyper branched poly(alkylethoxysiloxane), or a combination thereof. Typically, the one or more silicon resins may include, for example, about 20 to 40 mole percent branched polysiloxane, about 40 to 60 mole percent linear or cyclic polysiloxane, about 10 to 30 mole percent terminal polysiloxane, and about 1 to 5 mole percent monomeric siloxane.

Typically, the one or more silicon resins each independently include about 25 to 35 mole percent branched polysiloxane, about 45 to 55 mole percent linear or cyclic polysiloxane, about 15 to 25 mole percent terminal polysiloxane, and about 1 to 3 mole percent monomeric siloxane. Typically, the one or more silicon resins each independently include about 29 mole percent branched polysiloxane, about 50 mole percent linear or cyclic polysiloxane, about 19 mole percent terminal polysiloxane, and about 2 mole percent monomeric siloxane.

Suitable waxes may include, for example, one or more mineral waxes, one or more animal waxes, one or more plant waxes, one or more natural crystalline waxes, one or more synthetic crystalline waxes, or a combination thereof. Suitable mineral waxes may include, for example, paraffin, montan wax, lignite wax, osocerite, ceresin, utah wax, peat wax, Canadian balsam, terpene resin, xylene balsam, or a combination thereof.

Suitable animal waxes may include, for example, beeswax, Chinese wax, shellac wax, spermaceti, wool wax, or a combination thereof.

Suitable plant waxes may include, for example, bayberry, candelilla, carnauba, cotton, esparto, fir, Japan, ouricury, palm, rice-oil, sugar cane, ucuhuba, cocoa butter, or a combination thereof.

Suitable polyester resins may include, for example, one or more hydroxyl polyester resins, one or more carboxyl polyester resins, one or more isophthalic polyester resins, one or more orthophthalic polyester resins, or a combination thereof.

Suitable epoxy resins may include, for example, one or more glycidyl epoxy resins, one or more non-glycidyl resins, or a combination thereof. Typically, the one or more glycidyl epoxy resins may include, for example, one or more glycidyl-ether epoxy resins, one or more glycidyl-ester epoxy resins, one or more glycidyl-amine epoxy resins, or a combination thereof. Typically, the one or more non-glycidyl epoxy resins may include, for example, one or more aliphatic epoxy resins, one or more cycloaliphatic resins, or a combination thereof. Typically, the one or more epoxy resins may include, for example, one or more low viscosity, slow setting, and clear epoxy resins, one or more radiation-cured epoxy resins (e.g., ultraviolet cured), or one or more thermal cured epoxy resins.

Suitable epoxy resins may include, for example, C₄-C₂₈ alkyl glycidyl ethers, C₂-C₂₈ alkyl-glycidyl esters, C₂-C₂₈ alkenyl-glycidyl esters, C₁-C₂₈ alkyl-mono-phenol glycidyl ethers, C₁-C₂₈ alkyl-poly-phenol glycidyl ethers, pyrocatechol polyglycidyl ethers, resorcinol polyglycidyl ethers, hydroquinone polyglycidyl ethers, 4,4′-dihydroxydiphenyl methane polyglycidyl ethers, bisphenol F polyglycidyl ethers, 4,4′-dihydroxy-3,3′-dimethyldiphenyl methane polyglycidyl ethers, 4,4′-dihydroxydiphenyl dimethyl methane polyglycidyl ethers, bisphenol A polyglycidyl ethers, 4,4′-dihydroxydiphenyl methyl methane polyglycidyl ethers, 4,4′-dihydroxydiphenyl cyclohexane polyglycidyl ethers, 4,4′-dihydroxy-3,3′-dimethyldiphenyl propane polyglycidyl ethers, 4,4′-dihydroxydiphenyl sulfone polyglycidyl ethers, tris(4-hydroxyphyenyl)methane polyglycidyl ethers, novolac polyglycidyl ethers, diphenol polyglycidyl ethers, polyphenol polyglycidyl ethers, N,N′-diglycidyl-aniline, N,N′-dimethyl-N,N′-diglycidyl-4,4′-diaminodiphenyl methane, N,N,N′,N′-tetraglycidyl-4,4′-diaminodiphenyl methane, N,N′-diglycidyl-4-aminophenyl glycidyl ether, N,N,N′,N′-tetraglycidyl-1,3-propylene bis-4-aminobenzoate, phenol novolac epoxy resin, cresol novolac epoxy resin, sorbitol glycidyl ethers, phenolic polyglycidyl ethers, and combinations thereof.

Suitable texturing compositions may include, for example, one or more solvent based texturing compositions, one or more solvent-free texturing compositions, or a combination thereof.

Typically, the agglomerated stone composition includes, for example, a potassium oxide to silicon dioxide mole ratio from about 0.1 to about 0.4.

Typically, the agglomerated stone composition includes, for example, a potassium oxide to silicon dioxide mole ratio from about 0.2 to about 0.3. Typically, the agglomerated stone composition includes, for example, a silicon dioxide to aluminum oxide mole ratio from about 1.0 to about 5.0. Typically, the agglomerated stone composition includes, for example, a silicon dioxide to aluminum oxide mole ratio from about 2.0 to about 4.0. Typically, the agglomerated stone composition includes, for example, water to potassium oxide mole ratio from about 16 to about 22. Typically, the agglomerated stone composition includes, for example, water to potassium oxide mole ratio from about 18 to about 20.

Typically, the agglomerated stone composition includes, for example, a potassium oxide to aluminum oxide mole ratio from about 0.2 to about 1.5. Typically, the agglomerated stone composition includes, for example, a potassium oxide to aluminum oxide mole ratio from about 0.4 to about 1.1.

Typically, the agglomerated stone composition includes, for example, water to aluminum oxide mole ratio from about 5 to about 25. Typically, the agglomerated stone composition includes, for example, water to aluminum oxide mole ratio from about 10 to about 20.

Typically, the agglomerated stone composition further includes, for example, a colorant. Typically, the colorant includes, for example, a dye, a pigment, or a combination thereof.

Suitable black pigments may include, for example, inorganic pigments such as carbon black (C.I. Pigment black 7) such as furnace black, lamp black, acetylene black channel black, and the like; or organic black pigments such as Aniline Black (C.I. Pigment black 1), and the like.

Suitable colored pigments may include, for example, yellow pigments such as C.I. Pigment yellow 1 (Hanza Yellow G), 2, 3 (Hanza Yellow 10G), 4, 5 (Hanza Yellow 5G), 6, 7, 10, 11, 12 (Disazo Yellow AAA), 13, 14, 16, 17, 24 (Flavanthrone Yellow), 55 (Disazo Yellow AAPT), 61, 61:1, 65, 73, 74 (Fast Yellow 5GX), 81, 83 (Disazo Yellow HR), 93 (condensed azo yellow 3G), 94 (condensed azo yellow 6G), 95 (condensed azo yellow GR), 97 (Fast Yellow FGL), 99 (Anthraquinone), 100, 108 (Anthrapyrimidine Yellow), 109 (Isoindolinone Yellow 2GLT), 110 (Isoindolinone Yellow 3RLT), 117, 120 (Benzimidazolone Yellow H2G), 123 (Anthraquinone Yellow), 124, 128 (condensed azo yellow 8G), 129, 133, 138 (Quinophthalone Yellow), 139 (Isoindolinone Yellow), 147, 151 (Benzimidazolone Yellow H4G), 153 (Nickel Nitroso Yellow), 154 (Benzimidazolone Yellow H3G), 155, 156 (Benzimidazolone Yellow HLR), 167, 168, 172, 173 (Isoindolinone Yellow 6GL), and 180 (Benzimidazolone Yellow); red pigments such as C.I. Pigment red 1 (Para Red), 2, 3 (Toluidine Red), 4, 5 (ITR Red), 6, 7, 8, 9, 10, 11, 12, 14, 15, 16, 17, 18, 19, 21, 22, 23, 30, 31, 32, 37, 38 (Pyrazolone Red B), 40, 41, 42, 88 (Thioindigo Bordeaux), 112 (Naphthol Red FGR), 114 (Brilliant Carmine BS), 122 (Dimethyl Quinacridone), 123 (Perylene Vermillion), 144, 146, 149 (Perylene Scarlet), 150, 166, 168 (Anthanthrone Orange), 170 (Naphthol Red F3RK), 171 (Benzimidazolone Maroon HFM), 175 (Benzimidazolone Red HFT), 176 (Benzimidazolone HF3C), 177, 178 (Perylene Red), 179 (Perylene Maroon), 185 (Benzimidazolone Carmine HF4C), 187, 188, 189 (Perylene Red), 190 (Perylene Red), 194 (Perylene Red), 202 (Quinacridone Mazenta), 209 (Dichloroquinacridone Red), 214 (condensed Azo Red), 216, 219, 220 (Condensed Azo), 224 (Perylene Red), 242 (condensed Azo Scarlet), 245 (Naphthol Red), C.I. Pigment violet 19 (Quinacridone), 23 (Dioxazine Violet), 31, 32, 33, 36, 38, 43, and 50; blue pigments such as C.I. Pigment blue 15, 15:1, 15:2, 15:3, 15:4, 15:6 (Phthalocyanine Blue), 16 (metal-free Phthalocyanine Blue), 17:1, 18 (Alkali Blue Toner), 19, 21, 22, 25, 56, 60 (Threne Blue), 64 (Dichloroindanthrone Blue), 65 (Violanthrone), and 66 (Indigo); and additional colored pigments such as C.I. Pigment orange 1, 2, 5, 7, 13, 14, 15, 16 (Vulcan Orange), 24, 31 (condensed Azo Orange 4R), 34, 36 (Benzimidazolone Orange HL), 38, 40 (Pyranthrone Orange), 42 (isoindolinone Orange RLT), 43, 51, 60 (Benzimidazolone-based insoluble monoazo pigment), 62 (benzimidazone-based insoluble monoazo pigment), 63; C.I. Pigment green 7 (Phthalocyanine Green), 10 (Green Gold), 36 (chlorinated phthalocyanine green), 34, 47 (Violanthrone Green); C.I. Pigment brown 1, 2, 3, 5, 23 (condensed Azo Brown 5R), 25 (Benzimidazolone Brown HFR), 26 (Perylene Bordeaux), and 32 (Benzimidazolone Brown HFL).

When a pigment is used as the colorant, a pigment dispersant is preferably used in conjunction therewith. Pigment dispersants that can be used include, for example, polymer dispersants, anionic surfactants, cationic surfactants, amphoteric surfactants, nonionic surfactants, and combinations thereof. The colorants should be added in an effective amount to achieve the desired color.

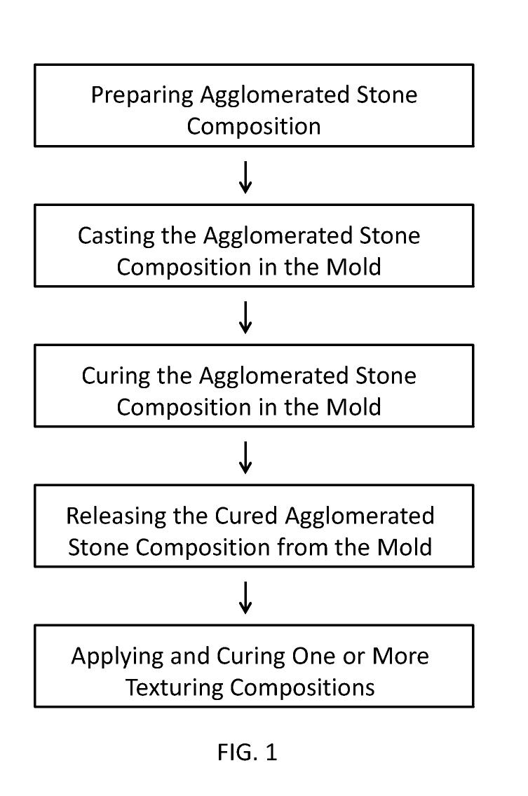

FIG. 1 illustrates a method of making a decorative stone composition. The method includes: preparing agglomerated stone composition including: kaolin, coal ash, blast furnace slag, or the combination thereof; one or more alkali metal silicates; one or more alkali metal hydroxide; one or more aggregate materials; water; preparing a mold having an inner surface; optionally applying a form releasing agent, a defoaming agent, or a combination thereof to the inner surface of the mold; casting the agglomerated stone composition in the mold; optionally consolidating the mixed agglomerated stone composition in the mold; optionally placing one or more rebars or one or more meshes into the mixed agglomerated stone composition; curing the agglomerated stone composition in the mold; releasing the cured agglomerated stone composition from the mold; applying one or more texturing compositions to the exterior surface of the cured agglomerated stone composition; optionally applying vibration or vacuum to the one or more texturing compositions on the exterior surface of the cured agglomerated stone composition; and curing the one or more texturing compositions.

### Preparing Agglomerated Stone Composition

The first step in preparing a decorative stone composition is to prepare an agglomerated stone composition. For example, about a 25-40 weight percent aqueous alkali metal silicate solution is prepared such that the weight ratio of silicon dioxide to alkali oxide is about 0.8 to about 1.8. To this solution is added a nearly completely dehydroxylated amorphous alumino-silicate powder with a mean particle size of about 1 to about 5 micron and mixed. The oxide mole ratios of the mixture should be about 2.45 to about 3.69 for SiO₂/Al₂O₃; about 0.21 to about 0.27 for K₂O/SiO₂; about 19.0 to about 19.38 for H₂O/K₂O; about 0.53 to about 1.02 for K₂O/Al₂O₃; and about 10.36 to about 19.82 for H₂O/Al₂O₃, wherein K represents an alkali metal such as sodium, potassium, lithium, and the like.

This composition is mixed until the dehydroxylated amorphous alumino-silicate powder is dissolved. To this solution is added the aggregate material and the combination mixed while avoiding air entrapment. Alternatively, the dehydroxylated amorphous alumino-silicate powder can be combined with the aggregate material and the combination aggregate material-dehydroxylated amorphous alumino-silicate powder is then added to the aqueous potassium silicate solution.

The particle size distribution and proportion of the aggregate material may be a factor in obtaining a realistic stone look. Preferably, the aggregate material should be a crushed aggregate material with a particle size distribution of about 20 to 40 weight percent of size #000 mesh, about 30 to 50 weight percent of size #00 mesh, about 30 to 50 weight percent of size #0 mesh, about 20 to 30 weight percent of size #1 mesh, or about 10 to 30 weight percent of size #000 mesh, about 50 to 70 weight percent of size #00 mesh, and about 10 to 40 weight percent of size #0 mesh. Larger aggregate material may also be used, for example, a 0.45 power chart provides the maximum packing density line, for example, percent passing=(d/D)^{0.45} where d=sieve size and D=nominal mat sieve size.

### Casting the Agglomerated Stone Composition

After mixing the agglomerated stone composition, preferably not longer than thirty minutes, the agglomerated stone composition may be cast into any type of mold. The mold may have an inner surface comprising plastic, rubber, metal, wood, cloth, paper, or a combination thereof. The mold may be made of non-combustible materials or combustible materials. Prior to casting, the mold may be treated with, for example, a releasing agent, a defoaming agent, or a combination thereof. Preferably, the mold should have a smooth inner surface.

During and after the agglomerated stone composition is cast into the mold, the mold is vibrated to remove air bubbles and improve the texture of the finished product. The vertical impacts increase the aggregate density on the surface and make the finished product appear more realistic. If needed, the liquid, which rises to the top of the mold while the aggregate settles, may be saturated with additional aggregate. After casting, the mold may be covered to prevent it from drying out and may be left undisturbed for about 1 hour to about 24 hours to allow the composition to gel.

### Curing the Agglomerated Stone Composition

Once the agglomerated stone composition has gelled, the sealed mold may be heated to about 80 degrees Fahrenheit to about 200 degrees Fahrenheit for about two hours to about 24 hours at ambient pressure, preferably, heated to about 210 degrees Fahrenheit to about 400 degrees Fahrenheit for about two hours to about 24 hours at a pressure at about 1 bar to about 17 bar.

After curing, the cured agglomerated stone composition is removed from the mold and the condensed water is allowed to escape from the pores of the cured agglomerated stone composition.

### Applying One or More Texturing Compositions

After the surface of the cured agglomerated stone composition is dry, the exterior surface is treated with one or more texturing compositions by brushing, dip-coating, spray coating, and the like, or a combination thereof. Any residual water and/or air in the pores of the cured agglomerated stone composition coated with one or more texturing compositions may be removed by applying a vacuum or pressure to force the one or more texturing compositions deep into the pores. Vibration may be applied during the coating to aid in the penetration of the one or more texturing compositions. Typically, two to four applications of the one or more texturing compositions afford the best results and provide a permanent textured appearance. Any excess resins should be removed after coating.

If the texturing compositions are omitted, the resulting cured agglomerated stone composition looks like cement or a homogenous gypsum surface, which is not esthetically pleasing.

If a glass aggregate is used, for example, soda lime silica glass, any specialty glass, or any reactive amorphous silica, the surface of the aggregate may be prepared with the additional process; otherwise, the final product will have a very low compressive strength of about 1200 pounds per square inch to about 1500 pounds per square inch.

The additional process includes treating the soda lime silica glass, any specialty glass, or any reactive amorphous silica with about 0.1 weight percent to about 10.0 weight percent aqueous lithium hydroxide solution. The solution may be applied by soaking the glass aggregate in lithium hydroxide solution for a period from about 5 minutes to about seventy-two hours at ambient temperature or elevated temperature (e.g., from about 65 degree Fahrenheit to about 400 degree Fahrenheit) and at either atmospheric pressure or at elevated pressure and heat. The glass aggregate may be dried at about 200 degrees Fahrenheit to about 500 degrees Fahrenheit before mixing in the glass aggregate into the agglomerated stone composition.

### Curing the One or More Texturing Compositions

After the surface of the cured agglomerated stone composition is treated with one or more texturing compositions, the decorative stone composition is cured at about room temperature for about 24 hours. If needed, the decorative stone composition may be polished. Also the contours of the decorative stone composition may be accentuated by a stone carving tool to provide a realistic stone carving.

In the claims provided herein, the steps specified to be taken in a claimed method or process may be carried out in any order without departing from the principles of the invention, except when a temporal or operational sequence is explicitly defined by claim language. Recitation in a claim to the effect that first a step is performed then several other steps are performed shall be taken to mean that the first step is performed before any of the other steps, but the other steps may be performed in any sequence unless a sequence is further specified within the other steps. For example, claim elements that recite “first A, then B, C, and D, and lastly E” shall be construed to mean step A must be first, step E must be last, but steps B, C, and D may be carried out in any sequence between steps A and E and the process of that sequence will still fall within the four corners of the claim.

Furthermore, in the claims provided herein, specified steps may be carried out concurrently unless explicit claim language requires that they be carried out separately or as parts of different processing operations. For example, a claimed step of doing X and a claimed step of doing Y may be conducted simultaneously within a single operation, and the resulting process will be covered by the claim. Thus, a step of doing X, a step of doing Y, and a step of doing Z may be conducted simultaneously within a single process step, or in two separate process steps, or in three separate process steps, and that process will still fall within the four corners of a claim that recites those three steps.

Similarly, except as explicitly required by claim language, a single substance or component may meet more than a single functional requirement, provided that the single substance fulfills the more than one functional requirement as specified by claim language.

All patents, patent applications, publications, scientific articles, web sites, and other documents and materials referenced or mentioned herein are indicative of the levels of skill of those skilled in the art to which the invention pertains, and each such referenced document and material is hereby incorporated by reference to the same extent as if it had been incorporated by reference in its entirety individually or set forth herein in its entirety. Additionally, all claims in this application, and all priority applications, including but not limited to original claims, are hereby incorporated in their entirety into, and form a part of, the written description of the invention. Applicants reserve the right to physically incorporate into this specification any and all materials and information from any such patents, applications, publications, scientific articles, web sites, electronically available information, and other referenced materials or documents. Applicants reserve the right to physically incorporate into any part of this document, including any part of the written description, the claims referred to above including but not limited to any original claims.

The invention should now be illustrated with the following non-limiting examples.

### EXAMPLES

Unless otherwise indicated, all numbers expressing quantities of ingredients, properties such as molecular weight, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contain certain errors necessarily resulting from the standard deviation found in their respective testing measurements.

### Example 1

To 44 grams of a 30 weight percent potassium silicate solution with a 2.5 weight ratio of SiO₂ to K₂O was added 6 grams of potassium hydroxide, stirred, and cooled to room temperature. To this composition was added about 22 grams of highly reactive metakaolin and the resulting suspension was stirred for about 10 minutes. To this suspension was added about 150 grams of crushed marble aggregate with about 20 weight percent of size #000 marble granules, about 60 weight percent of size #00 marble granules, and about 20 weight percent of size #0 marble granules. This mixture was slowly added to a mold while vibrating to eliminate the air bubbles. After about 90 percent of the mold was filled, size #00 marble granules were added to saturate the top liquid with marble aggregate. The mold was placed in a closed box or covered with a lid at room temperature for about 1 to about 24 hours with occasional tapping. Then mold was heated to about 150 degree Fahrenheit to about 190 degree Fahrenheit for about 3 hours to about 5 hours.

The mold was removed and the cured agglomerate was cooled to room temperature for about 5 minutes to about 100 minutes. The surface of the cured agglomerate was brushed with a hyperbranched polyalkylmethoxysiloxane texturing resin and placed at room temperature for about 30 minutes to about 2 hours. Any excess hyperbranched polyalkylmethoxysiloxane texturing resin was wiped off to afford the decorative stone product. The decorative stone product was placed at room temperature for about 24 hours and the texturing process discussed above was repeated to afford the final decorative product.

What is claimed is:

1. A decorative stone composition prepared by the process comprising:
mixing an agglomerated stone composition comprising
kaolin, coal ash, blast furnace slag, or the combination thereof;
one or more alkali metal silicates;
one or more alkali metal hydroxides;
one or more aggregate materials;
water;
curing the agglomerated stone composition;
treating the surface of the cured agglomerated stone composition with one or more texturing compositions; and
curing the one or more texturing compositions.

2. The decorative stone composition of claim 1, wherein the kaolin comprises a highly reactive metakaolin.

3. The decorative stone composition of claim 1, wherein the coal ash comprises fly ash.

4. The decorative stone composition of claim 1, wherein the one or more alkali metal silicates each independently comprise sodium silicate, potassium silicate, or a combination thereof.

5. The decorative stone composition of claim 1, wherein the one or more alkali metal silicates comprises an aqueous solution from about 10 weight percent to about 55 weight percent solid.

6. The decorative stone composition of claim 1, wherein the one or more alkali metal hydroxides each independently comprise lithium hydroxide, sodium hydroxide, potassium hydroxide, or a combination thereof.

7. The decorative stone composition of claim 1, wherein the one or more aggregate materials each independently comprise one or more granites, one or more marbles, one or more limestones, one or more sandstones, one or more semi-precious stones, one or more precious stones, one or more sands, one or more sea shells, one or more glasses, one or more bricks, one or more clinkers, one or more ceramics, one or more plastics, one or more semi-precious metals, one or more precious metals, one or more furnace slags, one or more granulated blast furnace slags, one or more volcanic stones, a combination thereof.

8. The decorative stone composition of claim 7, wherein the one or more aggregate materials each independently comprise one or more crushed aggregates having a particle size distribution of about 20 to 40 weight percent of size #000 mesh, about 30 to 50 weight percent of size #00 mesh, about 30 to 50 weight percent of size #0 mesh, about 20 to 30 weight percent of size #1 mesh.

9. The decorative stone composition of claim 1, wherein the one or more texturing compositions each independently comprise one or more silicon resins, one or more waxes, one or more acrylic resins, one or more polyester resins, one or more epoxy resins, one or more epoxy-silicon resins, one or more polyurethane resins, or a combination thereof.

10. The decorative stone composition of claim 9, wherein the one or more texturing compositions each independently comprise one or more silicon resins.

11. The decorative stone composition of claim 10, wherein the one or more silicon resins each independently comprise one or more hyper branched poly(alkylalkoxysiloxane) resins, one or more hyper branched poly(vinylalkoxysiloxane) resins, one or more dendrical poly(alkylalkoxysiloxane) resins, one or more dendrical poly(vinylalkoxysiloxane) resins, or a combination thereof.

12. The decorative stone composition of claim 11, wherein the one or more silicon resins each independently comprise about 20 to 40 mole percent branched polysiloxane, about 40 to 60 mole percent linear or cyclic polysiloxane, about 10 to 30 mole percent terminal polysiloxane, and about 1 to 5 mole percent monomeric siloxane.

13. The decorative stone composition of claim 12, wherein the one or more silicon resins each independently comprise about 25 to 35 mole percent branched polysiloxane, about 45 to 55 mole percent linear or cyclic polysiloxane, about 15 to 25 mole percent terminal polysiloxane, and about 1 to 3 mole percent monomeric siloxane.

14. The decorative stone composition of claim 12, wherein the one or more silicon resins each independently comprise about 29 mole percent branched polysiloxane, about 50 mole percent linear or cyclic polysiloxane, about 19 mole percent terminal polysiloxane, and about 2 mole percent monomeric siloxane.

15. The decorative stone composition of claim 1, wherein the curing a mixed agglomerated stone composition comprises heating the mixed agglomerated stone composition to about 80 degrees Fahrenheit to about 200 degrees Fahrenheit for about two hours to about 24 hours at ambient pressure.

16. The decorative stone composition of claim 1, wherein the treating the surface of the cured agglomerated stone composition with one or more texturing compositions comprises brushing the surface of the cured agglomerated stone composition with the one or more texturing compositions with vibration.

17. The decorative stone composition of claim 1, wherein the curing the one or more texturing compositions comprises leaving the cured agglomerated stone composition with one or more texturing compositions at about room temperature for about 24 hours.

18. A decorative stone composition comprising:
a cured agglomerated stone composition having an exterior surface comprising:
kaolin, coal ash, blast furnace slag, or the combination thereof;
one or more alkali metal silicates;
one or more alkali metal hydroxides;
one or more aggregate materials;
water; and
one or more cured texturing layers on the exterior surface of the cured agglomerated stone composition.

19. A method of making a decorative stone composition comprising:
preparing agglomerated stone composition comprising:
kaolin, coal ash, blast furnace slag, or the combination thereof;
one or more alkali metal silicates;
one or more alkali metal hydroxide;
one or more aggregate materials;
water;
preparing a mold having an inner surface;
optionally applying a form releasing agent, a defoaming agent, or a combination thereof to the inner surface of the mold;
casting the agglomerated stone composition in the mold;
optionally consolidating the mixed agglomerated stone composition in the mold;
optionally placing one or more rebars or one or more meshes into the mixed agglomerated stone composition;
curing the agglomerated stone composition in the mold;
releasing the cured agglomerated stone composition from the mold;
applying one or more texturing compositions to the exterior surface of the cured agglomerated stone composition;
optionally applying vibration or vacuum to the one or more texturing compositions on the exterior surface of the cured agglomerated stone composition; and
curing the one or more texturing compositions.

20. The method of claim 19, wherein the optionally consolidating the mixed agglomerated stone composition in the mold comprises aging at room temperature for about 2 to about 24 hours.
